(19) United States
(12) Patent Application Publication
(10) Pub. No.: US 2015/0149291 A1
(43) Pub. Date: May 28, 2015

(54) MAGNETIC CARD TRANSACTION SYSTEM BASED IN CLOUD COMPUTING AND SIMULATED MAGNETIC CARDS

(71) Applicant: Najla Ferraz Abdala, Temecula, CA (US)

(72) Inventor: Najla Ferraz Abdala, Temecula, CA (US)

(21) Appl. No.: 14/089,776

(22) Filed: Nov. 26, 2013

(51) Int. Cl. G06Q 40/00; G06Q 20/40; G06Q 20/36; G06Q 30/02

(52) U.S. Cl. CPC G06Q 40/00; G06Q 30/0268; G06Q 40/025; G06Q 20/40; G06Q 20/36
USPC 705/14.64; 705/39; 705/38; 705/44; 705/41

(57) ABSTRACT

A system based in cloud computing able to manage financial transactions related to debit and credit cards provided by financial institutions or service providers, using software applications or web application accessed by mobile devices or computer units and magnetic card simulators able to excite coils to simulate up to three credit and debit cards tracks avoiding the storage of magnetic card data.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF INVENTION

The magnetic stripe card technology invented by IBM in 1950 is still widely used around the world. There have been many attempts to introduce new technologies that enhance the level of security and improve the client-transaction process but these technologies require significant investment in new infrastructure. Thus, the simple magnetic strip reader continues to be used, being the dominant method utilized for consumer transactions.

There are countless point of sale (POS), automatic teller machines (ATM), electronic locks, and other machines that use regular magnetic card readers. Replacing all these terminals to support some of the proposed systems, and upgrading all client software associated with those systems, will incur in costs proportional to those millions of terminals, in addition to the cost of updating the equipment used by the consumers in the point-of-sale.

One example of a recent attempt of redefining the POS operation is the near-field-communication (NFC) technology using smartphones. While NFC is a significant enhancement over previous technologies, its adoption rate should be low, and costs high, for both consumers and businesses. The POS in the NFC technology is required to have an antenna, a software, a new reader, and a new communication system used just for this purpose, without the guarantee that the consumer will be using it during a purchase.

On the other hand, the current magnetic cards used by almost every consumer in the world are extremely simplistic: the data on these cards can be easily read, opening the opportunity for numerous crimes. Criminals can easily clone these cards by installing magnetic skimmers at ATMs, or by hacking the personal information of a consumer.

In some transactions, a personal identification number (PIN) is required from the consumer, helping to authenticate this consumer as the proper owner of the card.

While this method is an enhancement over a simple magnetic strip, it is neither consistently implemented (it is not required for credit cards) nor is it perfect (PINs can be stolen). A skimmed magnetic card, paired with a stolen pin, is a serious vulnerability of this authentication process.

In order to overcome this authentication vulnerability, usually a store clerk asks the consumer for additional identification in form of a document (identification card, passport). In this case, the personal privacy of the user is violated. Moreover this is not a perfect method of identification either: it is neither consistently implemented or reliable, and its success rate varies with the training of the employees, and their hability of identifying fraud.

There have been some attempts to unify the various magnetic cards that a consumer might carry, but none of them fully addresses the concerns outlined above. The problems inherent in these systems are described below:

U.S. Pat. No. 8,313,037 refers to a system that teaches the users how to clone their own cards, storing the card's pictures and data in their cell phones. The first problem of this invention is that users must have a magnetic card reader and a device to capture the images of the cards. The invention requires to connect the reader to a computer or mobile device to allow it to read the data of multiple cards; users have to capture a picture of each card (both front and back), associate all this information to each card that has been read, and to keep all of that information stored on the mobile device. The invention does not consider the possibility of receiving or accessing the card pictures and data remotely, what would avoid the need to receive a physical card from the financial institution. For example, all card information could be received directly from the bank through the Internet as data, saving the costs of creating and mailing the card to the user, as well as preventing any loss or theft of the card, but this option, as said before, is not covered by U.S. Pat. No. 8,313,037.

U.S. Pat. No. 8,313,037 also has a security flaw, since the data is stored in the cellular device, making the device itself a primary target for viruses to steal its contents, and for theft of the device itself. This patent doesn't consider the possibility of only temporarily storing the content, as the entire system described depends upon the cellular device storing that content.

U.S. Pat. No. 8,313,037 has also an usage flaw, as it only describes methods by which the user would manually interact with the hardware elements, pushing buttons or initializing the process via software stored in the cellular device. This patent doesn't consider the possibility of automatically detecting the swiping action of the device; it doesn't preserve the user's expected credit card like experience, requiring several extra steps.

Finally, regarding U.S. Pat. No. 8,313,037, this invention is limited to 3 possible configurations of the coils used to simulate magnetic fields, instead of discussing a flexible and easy to manufacture design, for example the process discussed in U.S. Pat. No. 4,791,283.

U.S. Pat. No. 7,828,214 refers to a method of connecting a magnetic stripe simulator to various “intelligent devices”, but does not consider a magnetic unit that could be retractable into the device. Also, while the patent does describe a method of authentication and approval using the network, the patent still requires to store the data in the “intelligent device”, subjecting the mobile device to problems of theft, hacking, and viral infiltration.

U.S. Pat. No. 4,605,844 refers to a solution similar to a smart-card. However, the main purpose of the patent is to power the Central Processing Unit (CPU) built into the smart-card wirelessly, as well as discussing the transmission of information via magnetic flux. This patent doesn't include communication with a smart device that can perform all the intelligence of the transaction via network communications. Instead, this patent requires to store all the intelligence and data in the smart-card. Also it does not include user and card identification required by in-store clerks.

So far, there is no invention that provides a way for consumers to perform their POS transactions through an intelligent device like a smartphone without carrying multiple cards or storing the card information in a device. There is no invention that uses cloud computing to direct the transaction and using encrypted cache data.

Also, there is no invention that provides a device that accurately simulates a magnetic stripe card, activating the swiping action using accelerometers, timers, voice command, gestures, or touch-screen actions.

Moreover, there is no invention that determines the current location of the device, determining, and limiting areas where specific cards may be used to perform transactions.

Nowadays banks send millions of cards every year. There is a cost involving the production of these cards that involves the use of plastic materials, added by the cost of packaging and delivery. These cards are usually delivered through regular mail, what takes time. There is no mechanism of digitally providing the information contained in the cards, saving time and money, and also reducing the environmental impact of the use of plastics and paper.

### BRIEF SUMMARY OF THE INVENTION

This invention describes a system able to perform financial transactions using Automated Teller Machine (ATM), Point of Sales (POS) or any type of operation involving magnetic card readers through a simulation of magnetic stripe cards (like debit, credit, prepaid and gift cards) and cloud computing, resolving all problems mentioned in the “background of the invention” of this patent.

The present invention also defines a mechanism of how to store, manage and authenticate multiple magnetic cards in clouding computing, carrying a single magnetic card simulator, enabling the user to perform operations through a mobile device selecting different cards named as virtual cards.

It uses applications or web applications where the users can keep representations of the virtual cards. These applications are called virtual wallets.

This system increases the security and allows to add new features without changes in the software or hardware used in ATMs or POS. It also stores the magnetic card data in a cloud computing system instead of using a physical device like FLASH, ROM, SD card, hard disk or any other kind of peripheral that stores data in the device.

The magnetic stripe card simulator is represented physically through a peripheral fixed or retractable on its own, or can be done using a separated peripheral able to communicate with a mobile device using wireless or wired communication.

When the user receives a credit, debit, pre-paid or gift card from a financial institution, store or service provider, the clouding server receives the essential information of the card with all data that exists in a regular card, e.g., expiration date, issue date, name in the card, security code and the data that would be saved in the stripped magnetic portion of the card.

Once the cloud receives the user information, a message is sent to the user's mobile device asking if the user accepts the card. This message might be received through a native application or an application downloaded in the device, a web application or any other regular mechanism to receive data, e.g., SMS, MMS, EMS, email, Bluetooth, NFC, http, https, sockets or content share.

If the card is accepted, the cloud receives a notification confirming the acceptance, and the user is able to use the “virtual card”.

Considering that the user is receiving the information digitally, different levels and types of encryption and authenticated methods can be applied on this process.

The users using a mobile device or computer can also initiate the process to receive the card. In this case, the user can apply to and receive the virtual card, or simply check if the financial institute has virtual cards available for him/her proving that the financial institution system is able to receive applications for virtual cards and to attend the users on demand.

It is important to clarify that the messages used in this process of virtual card acceptance are not necessarily synchronous but can be asynchronous in order to resolve latency issues in processing information or being part of a security mechanism.

Only minimum information should be stored in the mobile device to allow the user to see the card in the display but if the financial institution allows, a cache can be stored obeying different kind of security policies.

During this process of “virtual card” acceptance, the card provider might ask the users to set passwords or any other methods to increase the security of the transaction, for example, using token rings. The card provider may simply set the regular password or security methods used by the user or require no action. If nothing is required, the users will use the “virtual cards” as any other credit card, in other words, no password or any other input to increase the security will be required.

At this point, five problems are resolved:
1. The card providers will not need to send physical magnetic cards, reducing the production and shipping costs. Also they will be saving paper and reducing the environmental impact of plastic usage;
2. The users do not need to “clone” their own cards to save the magnetic card data like suggested by U.S. Pat. No. 8,313,037, where users have to take pictures of cards, read the magnetic stripe data using a reader and save all data in the mobile device In this present invention, Instead of cloning the card, the card provider sends electronically the all card information. It is safer to store the information in the clouds than in a device, and it is a solution easily accepted by card providers.
3. There is no relevant magnetic card information stored in the mobile device or in the own device emulator, reducing the risk of occurrence of illegal transactions with stolen and cloned cards;
4. Considering that passwords or any other security method is optional in the system (if required by the provider), the security level of the transactions will be improved without hardware or software changes in the ATM machines and POS machines;
5. Also, if passwords or any other security method are required by the provider, the user will not be required to show any identification document to the cashiers because even regular credit cards will have the same protection of debit cards where the identification documents are not required;

The user can select the virtual card using a graphical interface through a web application, downloadable or native application installed in the mobile device, and complete the transaction in a POS or ATM simply by pressing a button or touching a graphical or textual component in the screen, like graphical buttons in the display.

Considering that most mobile devices as smartphones and tablets contain microphones, cameras, gravity and accelerometer sensors, the system can use these peripherals and request different input signals in order to start the transaction, for example, a small slap in the device, a command voice, a shake, sound or face recognition or simply the software can start the transition as soon the user enters the password, or after the virtual card is chosen if no security is required.

Then the mobile device communicates with the magnetic card simulator. The magnetic card simulator converts the digital data into magnetic fields that are created when the coils are excited.

The communication between the mobile device and the magnetic card simulator can be done through wired or wireless communication, or direct from the mobile device when the magnetic card simulator and the mobile device comprise a single component or retractile mechanism.

The magnetic card simulator can assume three different formats:
1. The first format consists of coils in contact with a plastic surface. Each coil is positioned in a manner to simulate up to three tracks present in regular magnetic cards, in order to operate with card readers that read up to three tracks according to ISO 7811. On this configuration the plastic surface with coils must be thin enough to fit in the card reader, and to allow the coils to be positioned on each respective head track.
2. The second format consists of an only coil that generates a magnetic field. The magnetic card simulator is able to generate a magnetic field from a small distance from the reader, avoiding the need of insertion, similar to NFC (Near Field Communication). Only one coil is present in this configuration and the magnetic field generated simulates the track one. The advantage of this format is that there is no need to insert the card in the card reader.
3. The third configuration is a combination of the first and second formats previously mentioned. In this case the mobile device will have two magnetic card simulators, one of them simulates up to three coils that requires insertion in the card reader, and the second one generates the magnetic field to simulate track number one, and does not require insertion.

It is not necessary to swipe the card in all of those card configurations described above since the magnetic fields invert their orientations during the transmission of the data card, simulating the swiping process. If the user swipes the magnetic card simulator here is no impact in the functionality, because the magnetic field variation is uniform along the surface of the device.

Once the magnetic card data is sent to the card reader through the magnetic pulses generated by the magnetic card simulators, the transaction proceeds as any operation done using regular cards.

To enhance the system performance in case no data connection is available, the system might send periodically encrypted data that will be stored in the mobile device. This data is cached and might be encrypted. In case no data connection is available the data is decrypted and the user will be able to use the virtual card anyways. The system defines the periodicity that data is transmitted with or without different encryptions, and how long the cached data will last in the mobile device according to the requirements of the card provider. The card provider can change the cache policy based on location, for example, in case the user is overseas and limited data connection, allowing the cache to assume different life periods and remain stored longer.

### BRIEF DESCRIPTION OF THE DRAWINGS

FIG. 1 is an Unified Modeling Language (UML) sequence diagram that represents how the cloud allows the use of a virtual card and how the virtual card acceptance process works.

FIG. 2 is an UML sequence diagram that represents how the system works when the user apply for a new virtual card and the virtual card acceptance process during the application process.

FIG. 3 is an UML sequence diagram that represents the process when the software checks if there is connectivity present and how it is decided if the operation will be done through cloud or cache.

FIG. 4 represents how the operation proceeds when connectivity and cloud are available.

FIG. 5 represents how the operation proceeds when cache operation is necessary.

FIG. 6 represents a magnetic card simulator with three coils, wireless module, a driver, microcontroller, optional display and coin battery.

FIG. 7 represents a magnetic card simulator with three coils, wired connection, a driver, microcontroller, optional display and coin battery.

FIG. 8 represents a magnetic card simulator embedded in the mobile device and able to operate one single coil.

### DETAILED DESCRIPTION OF THE INVENTION

The invention defines a system based in cloud computing to manage multiple magnetic cards, allowing the usage of all of them using a single magnetic card simulator.

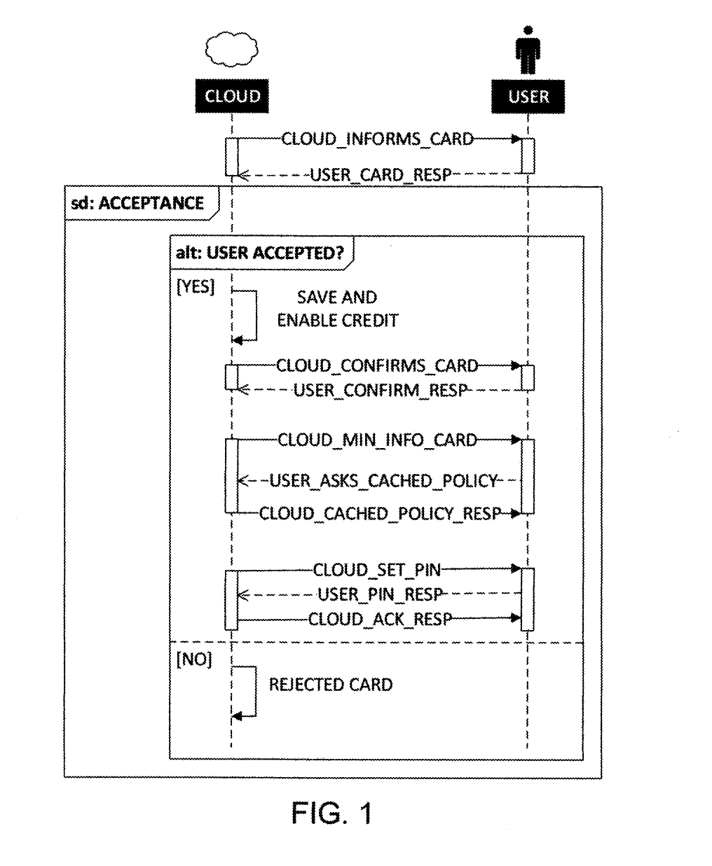

FIG. 1 represents the process when the cloud server offers credit to the user sending a message (CLOUD_INFORMS_CARD) to the mobile device or any other type of computer unit. The message is transmitted using SMS, MMS, EMS, email, sockets or any other mechanism able to transport the data message.

The user has option to accept or reject the offer or request. The response message (USER_{—} CARD_RESP) carries the decision and can be transmitted using the same mechanism of message receive, for example SMS, or can use a different mechanism to transport the response message.

In this case it is important to notice that the response does not need to be synchronous and the message transmitted might be encrypted and decrypted by the mobile device or computer unit according to financial institute requirements.

If user does not accept the card, the response message (USER_CARD_RESP) carries the decision and the cloud servers are informed the card was reject and the process is terminated.

However, once the user accepts the card sending the response message (USER_CARD_RESP), the server will process and respond with a new message (CLOUD_CONFIRMS_CARD), informing if the card was activated or not. This will avoid problems when the user responds asynchronously after a long period and some restriction occurred during this time preventing the user to keep the virtual card on his virtual wallet. A common example of this situation could be a credit rejection due to new event on user's credit report or simply expiration defined by the system or financial institute. If the card was accepted by user and server, the virtual wallet represented by the application or web application in the mobile device or computer unit, will store the new information as a new virtual card.

After the confirmation message from server is sent (CLOUD_CONFIRMS_CARD), Server is expected to receive a message from user (USER_CONFIRM_RESP) informing that the confirmation was processed.

A small portion of the card information sent by message (CLOUD_MIN_INFO_CARD) might be stored in the virtual wallet, such as the card image bitmap, expiration date, security code and issue date. These information received is used when user accesses the virtual wallet and choose the card. However crucial information as the magnetic stripe data, PIN code and/or passwords are not stored and are kept in the cloud.

When a minimal information is received it is possible to respond with a message (USER_ASKS_CACHED_POLICY). This message might be used as acknowledge of minimal card received and if the cached operation is allowed, the policy might be received by message (CLOUD_CACHED_POLICY_RESP) that can contains how the cache policy will work or if simply no cache policy is applicable.

The cached operation allows the user to utilize the virtual card when there is no connectivity available. The cache policy determines how long the cached data will be stored in the device, what kind of encryption and data is used, the location/area where the user is allowed to use the card, if a local PIN or password or any other type of authentication process will be required. If no cache policy is allowed, the user will not be able to use the virtual card if there is no connectivity.

If PIN and passwords settings are required, additional messages (CLOUD_SET_PIN) and responses messages from the user (USER_PIN_RESP) as acknowledgment messages (CLOUD_ACK_RESP) might be used with different types of encryptions and processes.

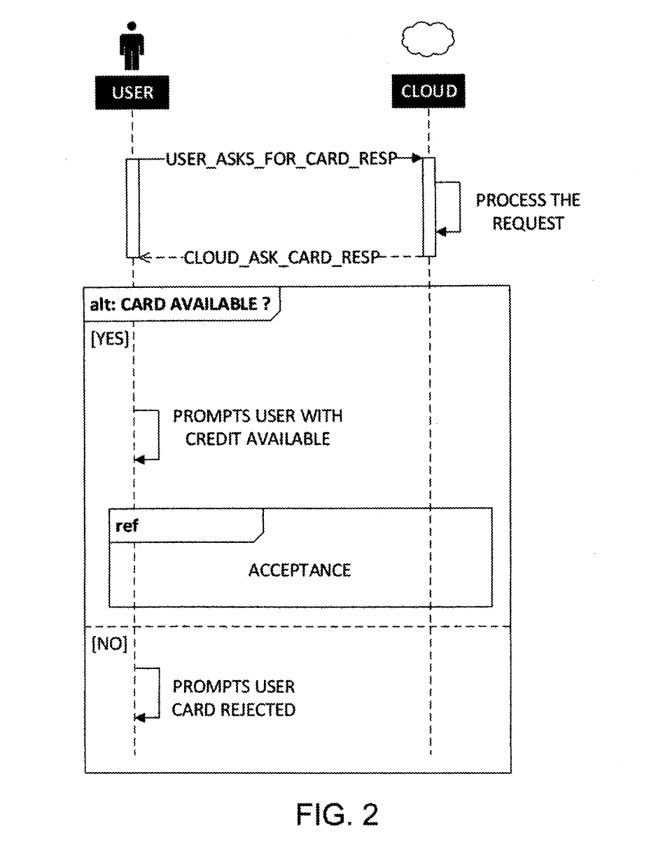

FIG. 2 represents the case when an user requests a new virtual card without receiving a notification offer from the financial institution. On this case a message (USER_ASKS_FOR_CARD) is sent by the user terminal: based on the user data provided with this message and/or information stored in the cloud, the institution will check if there are virtual cards immediately available for the user or process the request as a new approval process. If the virtual cards are available, the cloud can respond with a message (COUD_ASK_CARD_RESP) and this message can be synchronous or asynchronous depending if the virtual cards are available immediately or if some time is required is requested for processing respectively.

If virtual card is approved the user might be prompted with the credit limit and the user can accept or not the virtual card. If accepted the same messages sequences represented by the sequence diagram ACCEPTANCE in the FIG. 1 is used. If the clouds do not accept the new virtual card requested, the user might be prompted informed that the request was rejected.

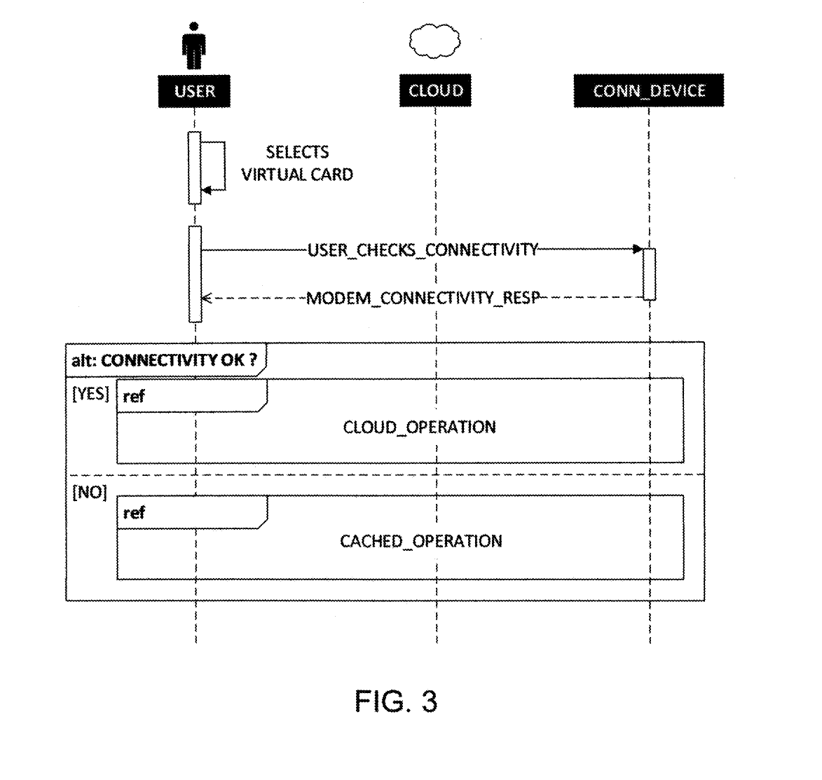

FIG. 3 represents a regular sequence of messages when the user wants to perform a financial transaction selecting one of the virtual cards she/he already has, using the graphical interface provided by the virtual wallet. Note that on this case, there is a representation of CONN_DEVICE object in the sequence diagram that receive a message (USER_CHECKS_CONNECTIVITY) in order to verify if there is connectivity available by receiving the message (MODEM_CONNECTIVITY_RESP) in return. Thus, the CONN_DEVICE is the object responsible to establish the connectivity of the mobile device or computer unit with the cloud servers through peripherals such as modems, Ethernet boards, Wi-Fi cards and any other device able to provide this interface.

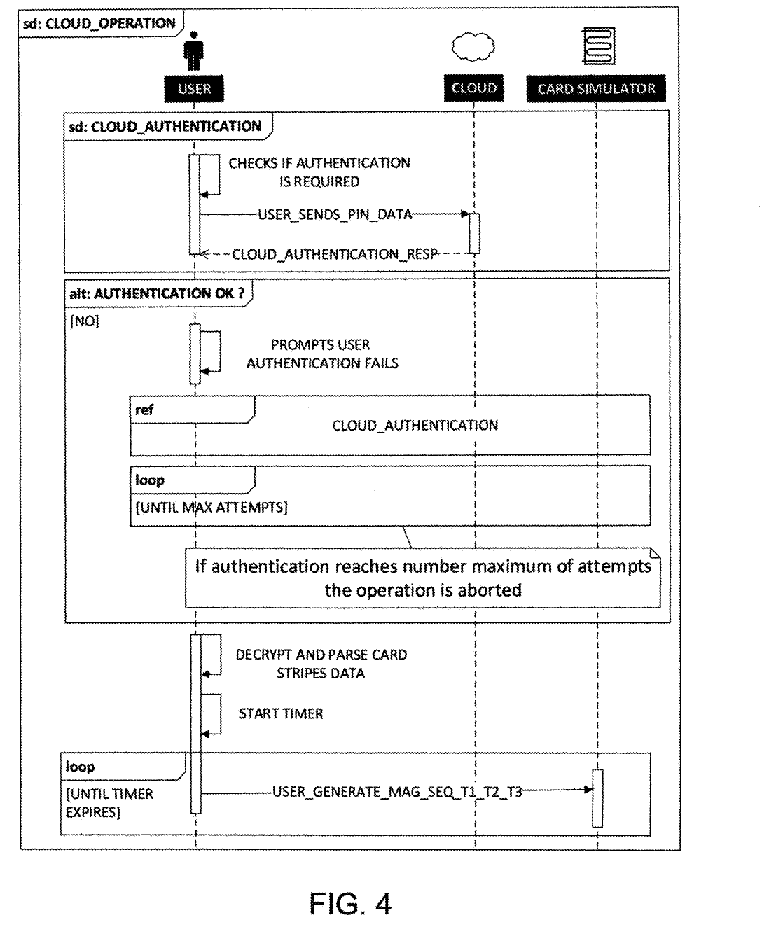

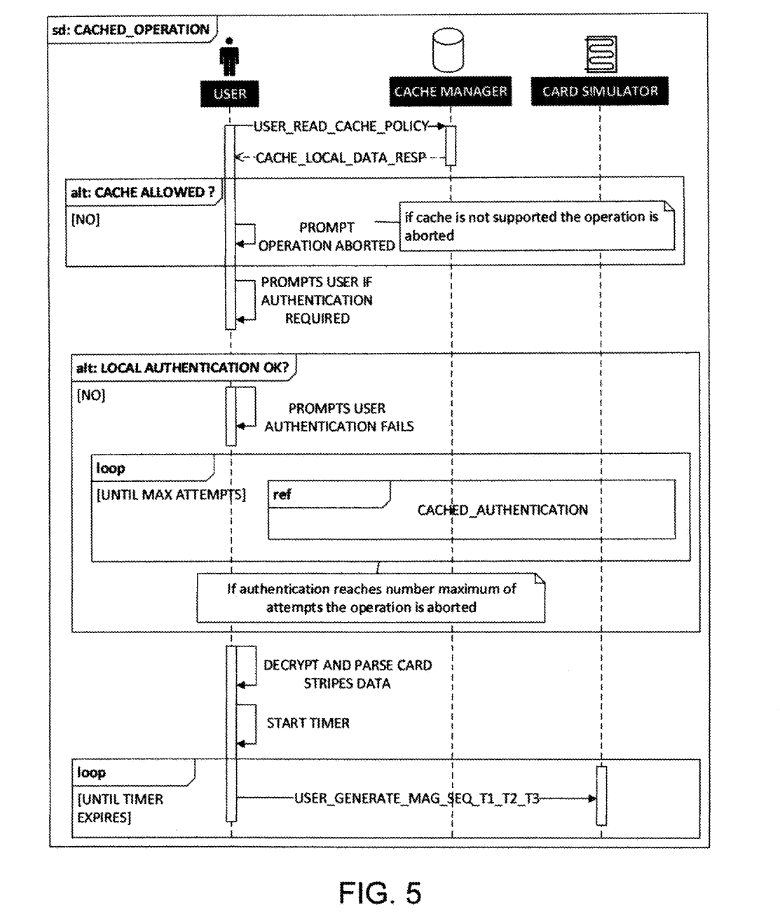

When connectivity is available the logic sequence is the one represented in FIG. 4, named CLOUD_OPERATION. When there is no connectivity, the sequence follows the sequence named CACHED_OPERATION represented in FIG. 5.

FIG. 4 represents the message flow when connectivity is available and the device or computer unit are able to communicate with cloud servers. It is possible that each virtual card received has different authentication processes as explained by FIG. 1 in the ACCEPTANCE sequence. If the virtual card chosen requires authentication, the user is prompted according the required authentication format, and a message (USER_SEND_PIN_DATA) is sent to the cloud following the required encryption.

Note that the authentication might be a sequence of numeric digits (PIN), password, face recognition (in case of mobile devices or computers with cameras), or any other type of authentication required. It is possible to require that the user enter more than one input data to perform the authentication, for example, some institutional banks in Brazil require not only the PIN but also an additional password.

The graphical interface must follow the authentication policy, allowing to the user to enter the data input required.

Once the authenticated message is sent, the cloud responds with a message (CLOUD_AUTHENTICATION_RESP) accepting or not this authentication.

If the authentication fails, the user might be prompted again until the maximum number of attempts is reached like a loop process. If the user fails in all the attempts, the operation is aborted and the cloud might be informed to lock the virtual card if the financial institution has this requirement.

If the authentication is accepted, the same message (CLOUD_AUTHENTICATION_RESP) might contain the magnetic card data that will be used to excite the coils of the card simulator. The data received might be encrypted and on this case the application must be able to decrypt and parse to have the raw bits sequence available. A separated message could be used to retrieve the magnetic stripes data, however, the same message (CLOUD_AUTHENTICATION_RESP) was used due to performance issues.

Once the data is available, the simulator of magnetic card is able to be excited. A timer is started and it is used to limit the period that the coils of the simulator card will remain excited.

FIG. 5 represents the sequence flow when there is no connectivity. The first message (USER_READ_CACHE_POLICY) will check with a component CACHE MANAGER supports cached operation and this component replies with a message (CACHE_LOCAL_DATA_RESP). This message (CACHE_LOCAL_DATA_RESP) informs if the cache is supported and which policy must be applied for such specific virtual card. If the cached operation is not supported, the operation is aborted and the user is informed. In case it is accepted, it is checked if authentication is required. If no authentication is required, the data in cache is parsed, decrypted and the magnetic card simulator is excited directly.

If an authentication process is required, the user is prompted and asked for a sequence of numeric digits (PIN), password, face recognition (in case of mobile devices or computers with cameras), or any other type of authentication available. A combination of PIN, password, or different input might be required as well. For example, the cache might require a password, e.g. a PIN number.

If the authentication fails during a cached operation, the system might prompt the user to enter the authentication data again until the maximum number of attempts is reached; if all attempts fail, the operation might be blocked and the virtual card might be locked locally, what means that the virtual card will remain located in the phone until a cloud operation is performed with success in case of connectivity present, or will remain locked according to the rules received during the cache operation or the rules established by the financial institution through the cloud server.

In both operations using cloud messages or cached data, when the communication flows right and when the user passed all required authentication processes, the magnetic stripe data is ready to be used exciting the magnetic card simulators.

There are different types of magnetic card simulators in the market and basically they are substantiated in coil induction. The present invention does not limit the use with specific types of magnetic card simulators. We explain the most common types In order to illustrate how the cards work and interact with the present invention.

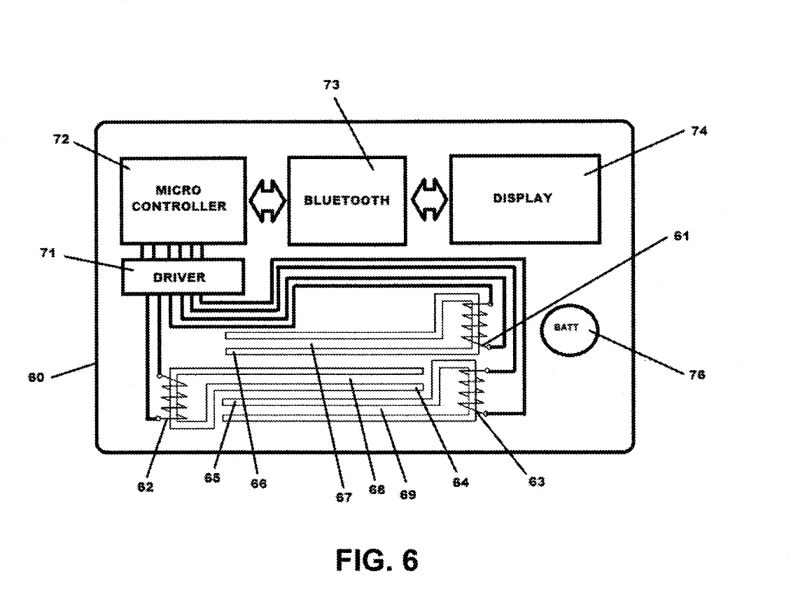

The first type of magnetic card is represented by FIG. 6 with a card body 60, where up to three coils 61, 62 and 63 might be present and each one enlaces a material with good properties for magnetic field generation forming poles 64, 65, 66 separated by small gaps 67, 68 and 69. In this case the gaps are properly spaced and the poles excited by the coils are positioned in order to represent the track 1 (defined by the Air Transport Association), track 2 (defined by the bank industry and widely used by ATM and POS), and track 3 (barely used by ATMs). Thus the credit and debit cards machines will not have problem in receiving this kind of card simulators because each track excited will have the magnetic field generated in a right position for each reader's head as any regular magnetic card.

In this simulator each coil is connected to a driver 71, responsible to transform the magnetic card data received digitally into analog current pulses, which generate magnetic fields on the pole. This digital to analog converter present in the driver, drives the current orientation and, consequently, the magnetic field generated has the orientation changed.

The data and driver management are controlled by a microcontroller 72 in the embodiment. This microcontroller might receive the data from the mobile device or computer unit using wired or wireless communications.

FIG. 6, shows a Bluetooth receiver 73 to illustrate the communication when wireless communication is used. Optionally, the display 74 can be present in the simulator and can have multiple functions, as informing the user how many time remains while the coil is excited, the card selected, the current balance available and other kind of information that could help the user during the transaction operation. For example, the user can give the card to a server in a restaurant and the server will be able to check how many seconds' remains in the card in order to be swiped in the card reader. The display can be simple LED or group of, LCD, e-paper, or any other technology able to give feedback to the user. When a wireless connection is used, the software application is able to notify the users if the users is away from the card, it means, if someone tries to steal the card or if the user loses the card, the application will inform the wireless connection was lost alerting the user immediately.

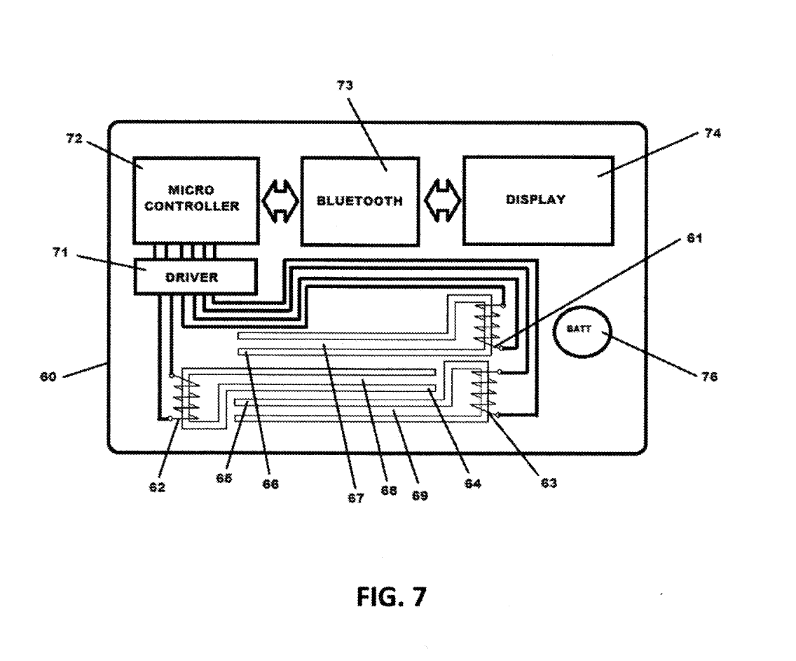

FIG. 7, also represents the card simulator based in coils. Instead of having an element that enables the wireless communication, there is a connector 75 that might be used to communicate and receive energy from the mobile device or computer unit. Note that if energy is received by a cable connected to the connector 75, the battery 76 illustrated in FIG. 6 is not present in the FIG. 7. The connector 75 in this case, might be an USB, audio jack or any other cable able to communicate with the card simulator. If the cable is not able to provide energy, a battery 76 must be present.

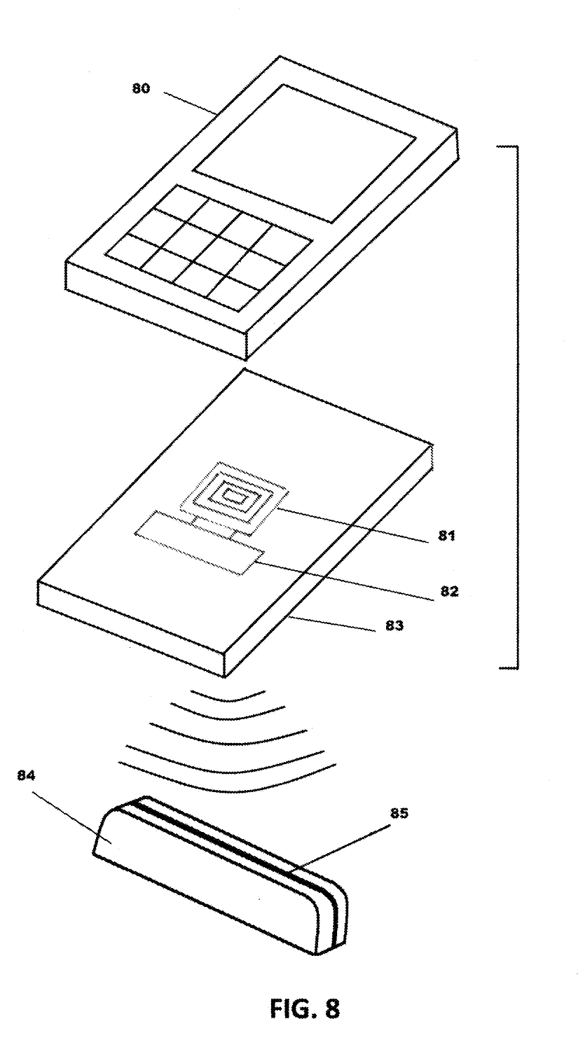

The second type of magnetic card simulator supported by this system is represented by FIG. 8 and it is common to be embedded or attached to the mobile device or computer unit. In such figure, the coil 81 is unique, connected to an internal circuit block 82 and it attached to back cover 83 of the mobile phone 80. The operation of this type simulator with regular credit and debit card reader 84 is similar to Near Field Communication procedure because this type of simulator is not inserted in the reader's gap 85 as a regular card, instead, the user needs to approach the simulator very close to the magnetic card reader and the magnetic field generated is able to excite the credit card reader. Only one reader's head will be able to receive and interpret the data even if is the card reader has three heads for each possible three tracks, due to the presence of one single coil and only one magnetic field generated, it is not possible to generate three distinguished fields at the same time with a different data format for each track. This kind of simulator limits the number of application and use cases. For example, it is not possible to withdraw money from an ATM terminal because it is not possible to insert the simulator in the ATM's card reader where more than one track is required in most of terminals.

Regarding the user interface provided by the application or web-application, the virtual wallet is able to suggest what is the best virtual card to use based on the balance available or other user preferences. To determine the balance available, the virtual wallet might consult the cloud services or save the balance available of different virtual cards locally in the device.

The user interface mentioned might also, allow the user to cancel one or more virtual cards, requesting the cancellation directly to the cloud services instead of waiting for the user to call the institution and the need to have human interaction for such operation. Authentication and personal info confirmation might be required as well during this cancellation process,

When a determined virtual card has cached operations approved by the financial or service provider, it is possible to change the cache policies periodically including encryption algorithm, or by system or user demand, in order to increase the security of the system and making more difficult the attack by common hack techniques. For example, every day when the mobile device or computer unit is idle, the software might communicate with the cloud server and receive a new key, changing the encryption applied in the caches totally transparent to the user, increasing the security of the system.

1. A system based in cloud computing able to manage financial transactions related to debit and credit cards provided by financial institutions and service providers, using magnetic card simulators through software applications and web applications accessed by mobile devices and computer units.

2. The system of claim 1, wherein sends notifications to mobile device and computer units with new credit cards offers in digital manner. These named virtual cards, are organized in digital wallets named virtual wallets controlled by software and replaces the need of carrying physical credit cards.

3. The system of claim 1, wherein receives card application forms from users and transmitting back to mobile devices and computer units, virtual cards when the user have credit qualified and approved by financial institutions and service providers.

4. The system of claim 1, wherein controls transactions related to credit and debit card operations when connectivity is present, allowing the mobile devices and computer units to access remotely the magnetic stripe card data and other relevant data remotely in a non-persisted and persisted form.

5. The system of claim 1, wherein the magnetic card data might be encrypted and additional and new authentication methods might be used in regular operations financial operations avoiding changes in software and hardware of regular ATM terminals and POS machines.

6. The system of claim 1, wherein locks and prevents the usage of credit and debit card's data when the authentication process fails, and when accessed remotely and by local caches, prevents the applications and web applications to excite the magnetic card simulators.

7. The system of claim 1, wherein stores in mobile devices and computer units, security policies and cached data in order to allow credit and debit card operations when there is no connectivity present.

8. The system of claim 1, wherein synchronizes with cloud services and update the caches, applying different policies, encryption and authentication rules periodically when demanded by the cloud services.

9. An application and web application as part of the system in claim 1, developed for mobile devices and computer units in order execute operations of debit and credit transactions using data received remotely from clouds servers and cached data according policy applied for each individual card received.

10. The application and web applications of claim 9, wherein decrypts and encrypts data received remotely and stored in data caches.

11. The application and web applications of claim 9, generates magnetic pulses thought magnetic card simulators with the data received in order to allow financial transactions in regular magnetic card readers.

12. The application and web applications of claim 9 wherein able to connect with different kinds of magnetic card simulators though mobile devices and computer units.

13. The application and web application of claim 9, wherein connects to the magnetic card simulators using wired or wireless connection.

14. The application and web application of claim 9, wherein alerts the users if the magnetic card simulators connected wirelessly are away from the mobile device or computer unit avoiding loss and theft of magnetic card simulators.

15. The application and web application of claim 9, wherein suggests the best virtual card stored in the virtual wallet, according to the balance available for each individual virtual card.

16. The application and web application of claim 9, wherein suggests the best virtual card stored in the virtual wallet, according to the user preference of virtual cards.
